(19) United States
(12) Patent Application Publication
(10) Pub. No.: US 2017/0269778 A1
(43) Pub. Date: Sep. 21, 2017

(54) FREQUENCY SHIFTING TECHNIQUES FOR CONCURRENT DISPLAY DRIVING AND TOUCH SENSING

(71) Applicant: SYNAPTICS INCORPORATED, San Jose, CA (US)

(72) Inventor: Kasra KHAZENI, San Jose, CA (US)

(21) Appl. No.: 15/070,451

(22) Filed: Mar. 15, 2016

(51) Int. Cl. G06F 3/041; G06F 3/044

(52) U.S. Cl. CPC G06F 3/0418; G06F 3/044; G06F 3/0412

(57) ABSTRACT

Techniques for adjusting a sensing frequency of a sensing signal are provided. The techniques include performing sensing and display updates with frequencies that have an integer ratio. The techniques include detecting a noise signal with a frequency similar to the sensing frequency. The techniques also include varying the integer ratio to achieve a desired sensing signal frequency.

### BACKGROUND

Field of the Disclosure

Embodiments generally relate to input sensing and, in particular, to frequency shifting techniques for concurrent display driving and touch sensing.

Description of the Related Art

Input devices including proximity sensor devices (also commonly called touchpads or touch sensor devices) are widely used in a variety of electronic systems. A proximity sensor device typically includes a sensing region, often demarked by a surface, in which the proximity sensor device determines the presence, location, and/or motion of one or more input objects. Proximity sensor devices may be used to provide interfaces for the electronic system. For example, proximity sensor devices are often used as input devices for larger computing systems (such as opaque touchpads integrated in, or peripheral to, notebook or desktop computers). Proximity sensor devices are also often used in smaller computing systems (such as touch screens integrated in cellular phones). Noise signals may reduce the ability of proximity sensor devices to determine presence or location of an input object.

### SUMMARY

A method for driving display updates and performing sensing is provided. The method includes driving a first plurality of display source lines for a first plurality of display line updates, wherein a first amount of time between a beginning of two consecutive display line updates of the first plurality of display line updates comprises a first display line time. The method also includes driving a plurality of capacitive sensor electrodes to perform a first number of sensing cycles during each of the first plurality of display line updates. The method further includes driving a second plurality of display source lines for a second plurality of display line updates, wherein a second amount of time between a beginning of two consecutive display line updates of the second plurality of display line updates comprises a second display line time. The method also includes driving the plurality of capacitive sensor electrodes to perform a second number of sensing cycles during each of the second plurality of display line updates, wherein the second number of sensing cycles is different from the first number of sensing cycles.

A processing system for driving display updates and performing sensing is also provided. The processing system includes a display driver configured to drive a first plurality of display source lines for a first plurality of display line updates, wherein a first amount of time between a beginning of two consecutive display line updates of the first plurality of display line updates comprises a first display line time, and drive a second plurality of display source lines for a second plurality of display line updates, wherein a second amount of time between a beginning of two consecutive display line updates of the second plurality of display line updates comprises a second display line time. The processing system also includes a sensor circuitry configured to drive a plurality of capacitive sensor electrodes to perform a first number of sensing cycles during each of the first plurality of display line updates, and drive the plurality of capacitive sensor electrodes to perform a second number of sensing cycles during each of the second plurality of display line updates, wherein the second number of sensing cycles is different from the first number of sensing cycles.

An input device for performing display updates and performing sensing is provided. The input device includes display source lines coupled to display elements, the display source lines including a first plurality of display source lines and a second plurality of display source lines, a plurality of capacitive sensor electrodes, and a processing system. The processing system includes a display driver configured to drive a first plurality of display source lines for a first plurality of display line updates, wherein a first amount of time between a beginning of two consecutive display line updates of the first plurality of display line updates comprises a first display line time, and drive a second plurality of display source lines for a second plurality of display line updates, wherein a second amount of time between a beginning of two consecutive display line updates of the second plurality of display line updates comprises a second display line time. The processing system also includes a sensor circuitry configured to drive a plurality of capacitive sensor electrodes to perform a first number of sensing cycles during each of the first plurality of display line updates, and drive the plurality of capacitive sensor electrodes to perform a second number of sensing cycles during each of the second plurality of display line updates, wherein the second number of sensing cycles is different from the first number of sensing cycles.

### BRIEF DESCRIPTION OF THE DRAWINGS

So that the manner in which the above recited features of embodiments can be understood in detail, a more particular description of embodiments, briefly summarized above, may be had by reference to embodiments, some of which are illustrated in the appended drawings. It is to be noted, however, that the appended drawings illustrate only typical embodiments and are therefore not to be considered limiting of scope, for other effective embodiments may be admitted.

FIG. 1 is a block diagram of a system that includes an input device according to an example.

FIG. 2A is a block diagram depicting a capacitive sensor device according to an example.

FIG. 2B is a block diagram depicting another capacitive sensor device according to an example.

FIG. 3 is a block diagram of a portion of the input device of FIG. 1, according to an example.

FIG. 4 is a timing diagram that illustrates timing relationships between display driving and sensor electrode driving, according to an example.

FIG. 5 illustrates a technique for changing frequency of a sensing signal, according to an example.

FIG. 6 is a spectrum chart that illustrates sensing frequencies over which input device may operate with techniques disclosed herein, according to an example.

FIG. 7 is a flow diagram of a method for adjusting sensing signal frequency, according to an example.

To facilitate understanding, identical reference numerals have been used, where possible, to designate identical elements that are common to the figures. It is contemplated that elements of one embodiment may be beneficially incorporated in other embodiments.

### DETAILED DESCRIPTION

The following detailed description is merely exemplary in nature and is not intended to limit the embodiments or the application and uses of such embodiments. Furthermore, there is no intention to be bound by any expressed or implied theory presented in the preceding technical field, background, brief summary or the following detailed description.

Various embodiments provide techniques for adjusting frequency of a sensing signal. The techniques are used in a system in which sensor electrodes are driven with sensing signals having a number of cycles that is an integer multiple of the number of display line periods, and also in which the phase of the sensing signals matches the phase of display line update signals (i.e., the relative phase between the sensing signals and the display line update signals is kept constant). According to the techniques, noise is detected in a resulting signal that results from driving a sensor electrode with a sensing signal as described above. The noise that is detected is at or near the frequency of the sensing signal, which triggers a “gear shift.” Gear shifting involves modifying the frequency of the sensing signal to avoid the noise. The allowable frequencies of the sensing signal are constrained by the above relationship to display line update signals. However, substantial flexibility is gained by modifying the integer ratio between the number of cycles in a sensing signal and the number of display line update periods. In one example, noise is detected at a frequency similar to the frequency of a sensing signal that includes four cycles per display line update period. In response to detecting this noise, the sensing signal is modified so that there are three or five cycles per display line update period, thereby avoiding the noise.

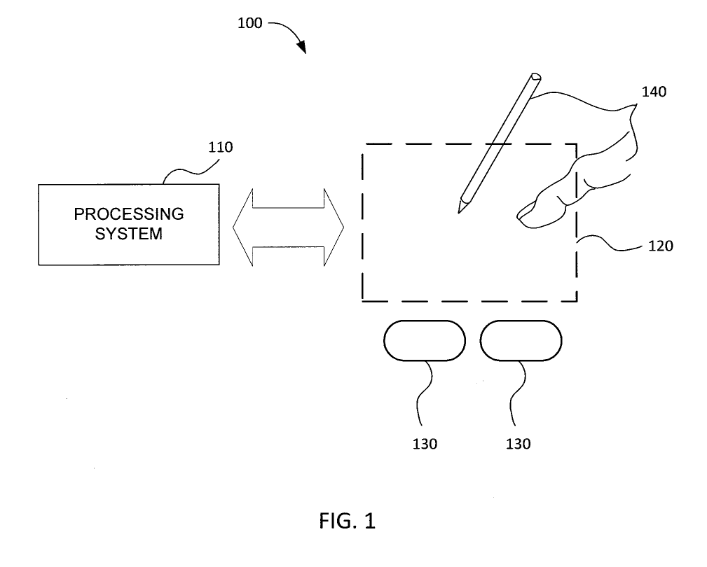

Turning now to the figures, FIG. 1 is a block diagram of an exemplary input device 100, in accordance with embodiments of the invention. The input device 100 may be configured to provide input to an electronic system (not shown). As used in this document, the term “electronic system” (or “electronic device”) broadly refers to any system capable of electronically processing information. Some non-limiting examples of electronic systems include personal computers of all sizes and shapes, such as desktop computers, laptop computers, netbook computers, tablets, web browsers, e-book readers, and personal digital assistants (PDAs). Additional example electronic systems include composite input devices, such as physical keyboards that include input device 100 and separate joysticks or key switches. Further example electronic systems include peripherals such as data input devices (including remote controls and mice), and data output devices (including display screens and printers). Other examples include remote terminals, kiosks, and video game machines (e.g., video game consoles, portable gaming devices, and the like). Other examples include communication devices (including cellular phones, such as smart phones), and media devices (including recorders, editors, and players such as televisions, set-top boxes, music players, digital photo frames, and digital cameras). Additionally, the electronic system could be a host or a slave to the input device.

The input device 100 can be implemented as a physical part of the electronic system or can be physically separate from the electronic system. As appropriate, the input device 100 may communicate with parts of the electronic system using any one or more of the following: buses, networks, and other wired or wireless interconnections. Examples include I²C, SPI, PS/2, Universal Serial Bus (USB), Bluetooth, RF, and IRDA.

In FIG. 1, the input device 100 is shown as a proximity sensor device (also often referred to as a “touchpad” or a “touch sensor device”) configured to sense input provided by one or more input objects 140 in a sensing region 120. Example input objects include fingers and styli, as shown in FIG. 1.

Sensing region 120 encompasses any space above, around, in, and/or near the input device 100 in which the input device 100 is able to detect user input (e.g., user input provided by one or more input objects 140). The sizes, shapes, and locations of particular sensing regions may vary widely from embodiment to embodiment. In some embodiments, the sensing region 120 extends from a surface of the input device 100 in one or more directions into space until signal-to-noise ratios prevent sufficiently accurate object detection. The distance to which this sensing region 120 extends in a particular direction, in various embodiments, may be on the order of less than a millimeter, millimeters, centimeters, or more, and may vary significantly with the type of sensing technology used and the accuracy desired. Thus, some embodiments sense input that comprises no contact with any surfaces of the input device 100, contact with an input surface (e.g., a touch surface) of the input device 100, contact with an input surface of the input device 100 coupled with some amount of applied force or pressure, and/or a combination thereof. In various embodiments, input surfaces may be provided by surfaces of casings within which the sensor electrodes reside, by face sheets applied over the sensor electrodes or any casings, etc. In some embodiments, the sensing region 120 has a rectangular shape when projected onto an input surface of the input device 100.

The input device 100 may utilize any combination of sensor components and sensing technologies to detect user input in the sensing region 120. The input device 100 comprises one or more sensing elements for detecting user input. As several non-limiting examples, the input device 100 may use capacitive, elastive, resistive, inductive, magnetic, acoustic, ultrasonic, and/or optical techniques. Some implementations are configured to provide images that span one, two, three, or higher dimensional spaces. Some implementations are configured to provide projections of input along particular axes or planes. In some resistive implementations of the input device 100, a flexible and conductive first layer is separated by one or more spacer elements from a conductive second layer. During operation, one or more voltage gradients are created across the layers. Pressing the flexible first layer may deflect it sufficiently to create electrical contact between the layers, resulting in voltage outputs reflective of the point(s) of contact between the layers. These voltage outputs may be used to determine positional information.

In some inductive implementations of the input device 100, one or more sensing elements pick up loop currents induced by a resonating coil or pair of coils. Some combination of the magnitude, phase, and frequency of the currents may then be used to determine positional information.

In some capacitive implementations of the input device 100, voltage or current is applied to create an electric field. Nearby input objects cause changes in the electric field and produce detectable changes in capacitive coupling that may be detected as changes in voltage, current, or the like.

Some capacitive implementations utilize arrays or other regular or irregular patterns of capacitive sensing elements to create electric fields. In some capacitive implementations, separate sensing elements may be ohmically shorted together to form larger sensor electrodes. Some capacitive implementations utilize resistive sheets, which may be uniformly resistive.

Some capacitive implementations utilize “self capacitance” (or “absolute capacitance”) sensing methods based on changes in the capacitive coupling between sensor electrodes and an input object. In various embodiments, an input object near the sensor electrodes alters the electric field near the sensor electrodes, changing the measured capacitive coupling. In one implementation, an absolute capacitance sensing method operates by modulating sensor electrodes with respect to a reference voltage (e.g., system ground) and by detecting the capacitive coupling between the sensor electrodes and input objects.

Some capacitive implementations utilize “mutual capacitance” (or “transcapacitance”) sensing methods based on changes in the capacitive coupling between sensor electrodes. In various embodiments, an input object near the sensor electrodes alters the electric field between the sensor electrodes, changing the measured capacitive coupling. In one implementation, a transcapacitive sensing method operates by detecting the capacitive coupling between one or more transmitter sensor electrodes (also “transmitter electrodes” or “transmitters”) and one or more receiver sensor electrodes (also “receiver electrodes” or “receivers”). Transmitter sensor electrodes may be modulated relative to a reference voltage (e.g., system ground) to transmit transmitter signals. Receiver sensor electrodes may be held substantially constant relative to the reference voltage to facilitate receipt of resulting signals. A resulting signal may comprise effect(s) corresponding to one or more transmitter signals and/or to one or more sources of environmental interference (e.g., other electromagnetic signals). Sensor electrodes may be dedicated transmitters or receivers, or sensor electrodes may be configured to both transmit and receive. Alternatively, the receiver electrodes may be modulated relative to ground.

In FIG. 1, a processing system 110 is shown as part of the input device 100. The processing system 110 is configured to operate the hardware of the input device 100 to detect input in the sensing region 120. The processing system 110 comprises parts of, or all of, one or more integrated circuits (ICs) and/or other circuitry components. For example, a processing system for a mutual capacitance sensor device may comprise transmitter circuitry configured to transmit signals with transmitter sensor electrodes and/or receiver circuitry configured to receive signals with receiver sensor electrodes. In some embodiments, the processing system 110 also comprises electronically-readable instructions, such as firmware code, software code, and/or the like. In some embodiments, components composing the processing system 110 are located together, such as near sensing element(s) of the input device 100. In other embodiments, components of processing system 110 are physically separate with one or more components close to sensing element(s) of input device 100 and one or more components elsewhere. For example, the input device 100 may be a peripheral coupled to a desktop computer, and the processing system 110 may comprise software configured to run on a central processing unit of the desktop computer and one or more ICs (perhaps with associated firmware) separate from the central processing unit. As another example, the input device 100 may be physically integrated in a phone, and the processing system 110 may comprise circuits and firmware that are part of a main processor of the phone. In some embodiments, the processing system 110 is dedicated to implementing the input device 100. In other embodiments, the processing system 110 also performs other functions, such as operating display screens, driving haptic actuators, etc.

The processing system 110 may be implemented as a set of modules that handle different functions of the processing system 110. Each module may comprise circuitry that is a part of the processing system 110, firmware, software, or a combination thereof. In various embodiments, different combinations of modules may be used. Example modules include hardware operation modules for operating hardware such as sensor electrodes and display screens, data processing modules for processing data such as sensor signals and positional information, and reporting modules for reporting information. Further example modules include sensor operation modules configured to operate sensing element(s) to detect input, identification modules configured to identify gestures such as mode changing gestures, and mode changing modules for changing operation modes.

In some embodiments, the processing system 110 responds to user input (or lack of user input) in the sensing region 120 directly by causing one or more actions. Example actions include changing operation modes, as well as GUI actions such as cursor movement, selection, menu navigation, and other functions. In some embodiments, the processing system 110 provides information about the input (or lack of input) to some part of the electronic system (e.g., to a central processing system of the electronic system that is separate from the processing system 110, if such a separate central processing system exists). In some embodiments, some part of the electronic system processes information received from the processing system 110 to act on user input, such as to facilitate a full range of actions, including mode changing actions and GUI actions.

For example, in some embodiments, the processing system 110 operates the sensing element(s) of the input device 100 to produce electrical signals indicative of input (or lack of input) in the sensing region 120. The processing system 110 may perform any appropriate amount of processing on the electrical signals in producing the information provided to the electronic system. For example, the processing system 110 may digitize analog electrical signals obtained from the sensor electrodes. As another example, the processing system 110 may perform filtering or other signal conditioning. As yet another example, the processing system 110 may subtract or otherwise account for a baseline, such that the information reflects a difference between the electrical signals and the baseline. As yet further examples, the processing system 110 may determine positional information, recognize inputs as commands, recognize handwriting, and the like.

“Positional information” as used herein broadly encompasses absolute position, relative position, velocity, acceleration, and other types of spatial information. Exemplary “zero-dimensional” positional information includes near/far or contact/no contact information. Exemplary “one-dimensional” positional information includes positions along an axis. Exemplary “two-dimensional” positional information includes motions in a plane. Exemplary “three-dimensional” positional information includes instantaneous or average velocities in space. Further examples include other representations of spatial information. Historical data regarding one or more types of positional information may also be determined and/or stored, including, for example, historical data that tracks position, motion, or instantaneous velocity over time.

In some embodiments, the input device 100 is implemented with additional input components that are operated by the processing system 110 or by some other processing system. These additional input components may provide redundant functionality for input in the sensing region 120 or some other functionality. FIG. 1 shows buttons 130 near the sensing region 120 that can be used to facilitate selection of items using the input device 100. Other types of additional input components include sliders, balls, wheels, switches, and the like. Conversely, in some embodiments, the input device 100 may be implemented with no other input components.

In some embodiments, the input device 100 comprises a touch screen interface, and the sensing region 120 overlaps at least part of an active area of a display screen. For example, the input device 100 may comprise substantially transparent sensor electrodes overlaying the display screen and provide a touch screen interface for the associated electronic system. The display screen may be any type of dynamic display capable of displaying a visual interface to a user, and may include any type of light emitting diode (LED), organic LED (OLED), cathode ray tube (CRT), liquid crystal display (LCD), plasma, electroluminescence (EL), or other display technology. The input device 100 and the display screen may share physical elements. For example, some embodiments may utilize some of the same electrical components for displaying and sensing. As another example, the display screen may be operated in part or in total by the processing system 110.

It should be understood that while many embodiments of the invention are described in the context of a fully functioning apparatus, the mechanisms of the present invention are capable of being distributed as a program product (e.g., software) in a variety of forms. For example, the mechanisms of the present invention may be implemented and distributed as a software program on information bearing media that are readable by electronic processors (e.g., non-transitory computer-readable and/or recordable/writable information bearing media readable by the processing system 110). Additionally, the embodiments of the present invention apply equally regardless of the particular type of medium used to carry out the distribution. Examples of non-transitory, electronically readable media include various discs, memory sticks, memory cards, memory modules, and the like. Electronically readable media may be based on flash, optical, magnetic, holographic, or any other storage technology.

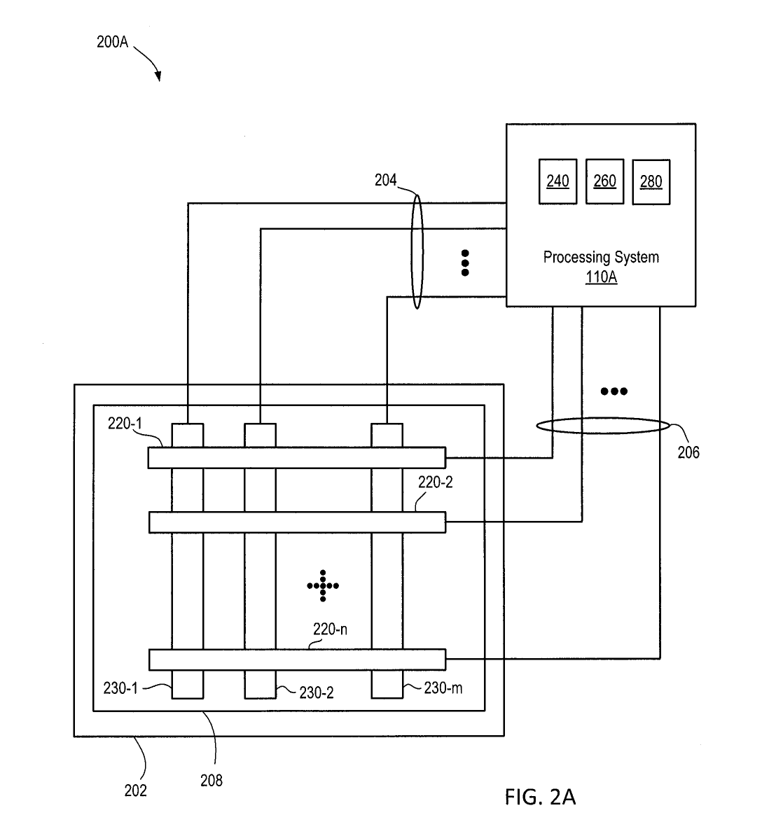

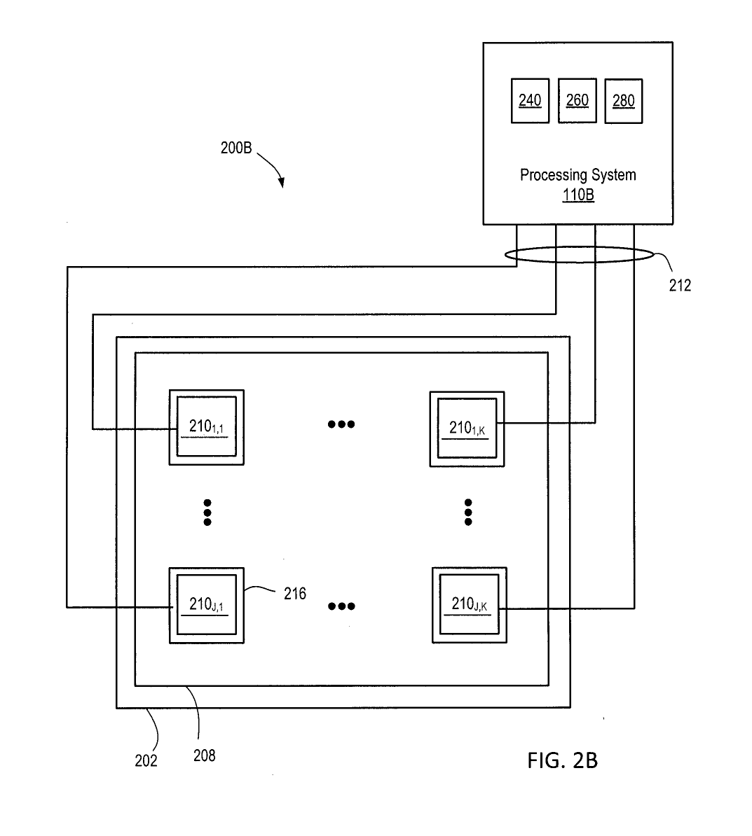

FIG. 2A is a block diagram depicting a capacitive sensor device 200A according to an example. The capacitive sensor device 200A comprises an example implementation of the input device 100 shown in FIG. 1. The capacitive sensor device 200A includes a sensor electrode collection 208 coupled to an example implementation of the processing system 110 (referred to as “the processing system 110A”). As used herein, general reference to the processing system 110 is a reference to the processing system described in FIG. 1 or any other embodiment thereof described herein (e.g., the processing system 110A, 110B, etc.). Note that in some embodiments, unless otherwise stated, processing system 110B performs the same functionality as processing system 110A.

The sensor electrode collection 208 is disposed on a substrate 202 to provide the sensing region 120. The sensor electrode collection 208 includes sensor electrodes disposed on the substrate 202. In the present example, the sensor electrode collection 208 includes two pluralities of sensor electrodes 220-1 through 220-N (collectively “sensor electrodes 220”), and 230-1 through 230-M (collectively “sensor electrodes 230”), where M and N are integers greater than zero. The sensor electrodes 220 and 230 are separated by a dielectric (not shown). The sensor electrodes 220 and the sensor electrodes 230 can be non-parallel. In an example, the sensor electrodes 220 are disposed orthogonally with the sensor electrodes 230.

In some examples, the sensor electrodes 220 and the sensor electrodes 230 can be disposed on separate layers of the substrate 202. In other examples, the sensor electrodes 220 and the sensor electrodes 230 can be disposed on a single layer of the substrate 202. While the sensor electrodes are shown disposed on a single substrate 202, in some embodiments, the sensor electrodes can be disposed on more than one substrate. For example, some sensor electrodes can be disposed on a first substrate, and other sensor electrodes can be disposed on a second substrate adhered to the first substrate.

In the present example, the sensor electrode collection 208 is shown with the sensor electrodes 220, 230 generally arranged in a rectangular grid of intersections of orthogonal sensor electrodes. It is to be understood that the sensor electrode collection 208 is not limited to such an arrangement, but instead can include numerous sensor patterns. Although the sensor electrode collection 208 is depicted as rectangular, the sensor electrode collection 208 can have other shapes, such as a circular shape.

As discussed below, the processing system 110A can operate the sensor electrodes 220, 230 according to a plurality of excitation schemes, including excitation scheme(s) for mutual capacitance sensing (“transcapacitive sensing”) and/or self-capacitance sensing (“absolute capacitive sensing”). In a transcapacitive excitation scheme, the processing system 110A drives the sensor electrodes 230 with transmitter signals (the sensor electrodes 230 are “transmitter electrodes”), and receives resulting signals from the sensor electrodes 220 (the sensor electrodes 220 are “receiver electrodes”). In some embodiments, sensor electrodes 220 may be driven as transmitter electrodes and sensor electrodes 230 may be operated as receiver electrodes. The sensor electrodes 230 can have the same or different geometry as the sensor electrodes 220. In an example, the sensor electrodes 230 are wider and more closely distributed than the sensor electrodes 220, which are thinner and more sparsely distributed. Similarly, in an embodiment, sensor electrodes 220 may be wider and/or more sparsely distributed. Alternatively, the sensor electrodes 220, 230 can have the same width and/or the same distribution.

The sensor electrodes 220 and the sensor electrodes 230 are coupled to the processing system 110A by conductive routing traces 204 and conductive routing traces 206, respectively. The processing system 110A is coupled to the sensor electrodes 220, 230 through the conductive routing traces 204, 206 to implement the sensing region 120 for sensing inputs. Each of the sensor electrodes 220 can be coupled to at least one routing trace of the routing traces 206. Likewise, each of the sensor electrodes 230 can be coupled to at least one routing trace of the routing traces 204.

FIG. 2B is a block diagram depicting a capacitive sensor device 200B according to an example. The capacitive sensor device 200B comprises another example implementation of the input device 100 shown in FIG. 1. In the present example, the sensor electrode collection 208 includes a plurality of sensor electrodes 210_{1,1} through 210_{J,K}, where J and K are integers (collectively “sensor electrodes 210”). In the present example, the sensor electrodes 210 are arranged in a rectangular matrix pattern, where at least one of J or K is greater than zero. The sensor electrodes 210 can be arranged in other patterns, such as polar arrays, repeating patterns, non-repeating patterns, or like type arrangements. In various embodiments, the grid electrode(s) is optional and may not be included. Similar to the capacitive sensor device 200A, the processing system 110B can operate the sensor electrodes 210 according to a plurality of excitation schemes, including excitation scheme(s) for transcapacitive sensing and/or absolute capacitive sensing.

In some examples, the sensor electrodes 210 can be disposed on separate layers of the substrate 202. In other examples, the sensor electrodes 210 can be disposed on a single layer of the substrate 202. The sensor electrodes 210 can be on the same and/or different layers as the sensor electrodes 220 and the sensor electrodes 230. While the sensor electrodes are shown disposed on a single substrate 202, in some embodiments, the sensor electrodes can be disposed on more than one substrate. For example, some sensor electrodes can be disposed on a first substrate, and other sensor electrodes can be disposed on a second substrate adhered to the first substrate.

The processing system 110B is coupled to the sensor electrodes 210 through the conductive routing traces 212 to implement the sensing region 120 for sensing inputs. In one or more embodiments, sensor electrode collection 208 may further comprise one or more grid electrodes that are disposed between sensor electrodes 210. The grid electrode(s) may at least partially encompass one or more of the sensor electrodes 210.

Referring to FIGS. 2A and 2B, the capacitive sensor device 200A or 200B can be utilized to communicate user input (e.g., a user's finger, a probe such as a stylus, and/or some other external input object) to an electronic system (e.g., computing device or other electronic device). For example, the capacitive sensor device 200A or 200B can be implemented as a capacitive touch screen device that can be placed over an underlying image or information display device (not shown). In this manner, a user would view the underlying image or information display by looking through substantially transparent elements in the sensor electrode collection 208. When implemented in a touch screen, the substrate 202 can include at least one substantially transparent layer (not shown). The sensor electrodes and the conductive routing traces can be formed of substantially transparent conductive material. Indium tin oxide (ITO) and/or thin, barely visible wires are but two of many possible examples of substantially transparent material that can be used to form the sensor electrodes and/or the conductive routing traces. In other examples, the conductive routing traces can be formed of non-transparent material, and then hidden in a border region (not shown) of the sensor electrode collection 208.

In another example, the capacitive sensor device 200A or 200B can be implemented as a capacitive touchpad, slider, button, or other capacitance sensor. For example, the substrate 202 can be implemented with, but not limited to, one or more clear or opaque materials. Likewise, clear or opaque conductive materials can be utilized to form sensor electrodes and/or conductive routing traces for the sensor electrode collection 208.

In general, the processing system 110 (note, processing system 110 may refer to either or 110A or 110B) excites or drives sensing elements of the sensor electrode collection 208 with a sensing signal and measures an induced or resulting signal that includes effects corresponding to at least one of the sensing signal, an input object, and interference in the sensing region 120. The terms “excite” and “drive” as used herein encompasses controlling some electrical aspect of the driven element. For example, it is possible to drive current through a wire, drive charge into a conductor, drive a substantially constant or varying voltage waveform onto an electrode, etc. A sensing signal can be constant, substantially constant, or varying over time, and generally includes a shape, frequency, amplitude, and phase. A sensing signal can be referred to as an “active signal” as opposed to a “passive signal,” such as a ground signal or other reference signal. A sensing signal can also be referred to as a “transmitter signal” when used in transcapacitive sensing, or an “absolute sensing signal” or “modulated signal” when used in absolute sensing.

In an example, the processing system 110 drives one or more sensor electrodes of the sensor electrode collection 208 with a voltage and senses resulting respective charge on the sensor electrode(s). That is, the sensing signal is a voltage signal and the resulting signal is a charge signal (e.g., a signal indicative of accumulated charge, such as an integrated current signal). Capacitance is proportional to applied voltage and inversely proportional to accumulated charge. The processing system 110 can determine measurement(s) of capacitance from the sensed charge. In another example, the processing system 110 drives one or more sensor electrodes of the sensor electrode collection 208 with charge and senses resulting respective voltage on sensor electrode(s). That is, the sensing signal is a signal to cause accumulation of charge (e.g., current signal) and the resulting signal is a voltage signal. The processing system 110 can determine measurement(s) of capacitance from the sensed voltage. In general, the term “sensing signal” is meant to encompass both driving voltage to sense charge and driving charge to sense voltage, as well as any other type of signal that can be used to obtain indicia of capacitance. “Indicia of capacitance” include measurements of charge, current, voltage, and the like, from which capacitance can be derived.

The processing system 110 can include a sensor circuitry 240. The sensor circuitry 240 performs sensing-related functions of the processing system 110, such as driving sensor electrodes with signals for sensing, receiving signals from sensor electrode for processing, and other functions. The sensor circuitry 240 may be part of a sensor module that includes firmware, software, or a combination thereof operating in cooperation with the circuitry.

In some embodiments processing system 110 includes a determination module 260. The determination module 260 may be embodied as, or may include, a determination processor that is configured to perform some or all of the operations described as being performed by the determination module 260 herein, such as analyzing signals received via sensor circuitry 240 to determine presence of an input object. In some embodiments, the determination processor is a microprocessor, microcontroller, or other instruction processing electronic element that executes instructions, in the form of software or firmware, for performing such operations. In other embodiments, the determination processor is an application specific integrated circuit having circuit elements selected and arranged to perform the described operations. Note that in various embodiments, the determination processor is included within the same integrated circuit as some or all of the other portions of the processing system 110.

Note that functionality performed by sensor circuitry 240 and determination module 260 may be considered to be performed by processing system 110. Note also that although both sensor circuitry 240 and determination module 260 are described, and that specific functionality are ascribed to these elements, in various embodiments, functionality may be split amongst the sensor circuitry 240 and determination module 260 in different ways.

The sensor circuitry 240 selectively drives sensing signal(s) on one or more sensing elements of the sensor electrode collection 208 over one or more cycles (“excitation cycles”) in accordance with one or more schemes (“excitation schemes”). During each excitation cycle, the sensor circuitry 240 can selectively sense resulting signal(s) from one or more sensing elements of the sensor electrode collection 208. Each excitation cycle has an associated time period during which sensing signals are driven and resulting signals measured.

In one type of excitation scheme, the sensor circuitry 240 can selectively drive sensing elements of the sensor electrode collection 208 for absolute capacitive sensing. In absolute capacitive sensing, the sensor circuitry 240 drives selected sensor electrode(s) with an absolute sensing signal and senses resulting signal(s) from the selected sensor electrode(s). In such an excitation scheme, measurements of absolute capacitance between the selected sensing element(s) and input object(s) are determined from the resulting signal(s). In an example, the sensor circuitry 240 can drive selected sensor electrodes 220, and/or selected sensor electrodes 230, with an absolute sensing signal. In another example, the sensor circuitry 240 can drive selected sensor electrodes 210 with an absolute sensing signal.

In another type of excitation scheme, the sensor circuitry 240 can selectively drive sensing elements of the sensor electrode collection 208 for transcapacitive sensing. In transcapacitive sensing, the sensor circuitry 240 drives selected transmitter sensor electrodes with transmitter signal(s) and senses resulting signals from selected receiver sensor electrodes. In such an excitation scheme, measurements of transcapacitance between transmitter and receiver electrodes are determined from the resulting signals. In an example, the sensor circuitry 240 can drive the sensor electrodes 230 with transmitter signal(s) and receive resulting signals on the sensor electrodes 220. In another example, the sensor circuitry 240 can drive selected sensor electrodes 210 with transmitter signal(s), and receive resulting signals from others of the sensor electrodes 210.

In any excitation cycle, the sensor circuitry 240 can drive sensing elements of the sensor electrode collection 208 with other signals, such as shielding or shield signals. A shield signal may be any substantially constant voltage signal or a varying voltage signal. The sensor electrodes of sensor electrode collection 208 that are not driven with a sensing signal, or sensed to receive resulting signals, can be driven with a shield signal or left floating (i.e., not driven with any signal). The shield signal may be a ground signal (e.g., system ground) of the input device. A shield signal comprising a varying voltage signal may also be referred to as a guard signal. Such a signal can be a signal that is similar or the same in at least one of shape, amplitude, frequency, or phase of a transmitter signal or the absolute capacitive sensing signal.

“System ground” may indicate any reference voltage of the input device 100. For example, a capacitive sensing system of a mobile device can, at times, be referenced to a system ground provided by the phone's power source (e.g., a charger or battery). The system ground may not be fixed relative to earth or any other reference. For example, a mobile device on a table usually has a floating system ground. A mobile device being held by a person who is strongly coupled to earth ground through free space may be grounded relative to the person, but the person-ground may be varying relative to earth ground. In many systems, the system ground is connected to, or provided by, the largest area electrode in the system. The capacitive sensor device 200A or 200B can be located proximate to such a system ground electrode (e.g., located above a ground plane or backplane).

The determination module 260 performs capacitance measurements based on resulting signals obtained by the sensor circuitry 240. The capacitance measurements can include changes in capacitive couplings between elements (also referred to as “changes in capacitance”). For example, the determination module 260 can determine baseline measurements of capacitive couplings between elements without the presence of input object(s). The determination module 260 can then combine the baseline measurements of capacitive couplings with measurements of capacitive couplings in the presence of input object(s) to determine changes in capacitive couplings.

In an example, the determination module 260 can perform a plurality of capacitance measurements associated with specific portions of the sensing region 120 as “capacitive pixels” to create a “capacitive image” or “capacitive frame.” A capacitive pixel of a capacitive image represents a location within the sensing region 120 in which a capacitive coupling can be measured using sensing elements of the sensor electrode collection 208. For example, a capacitive pixel can correspond to a transcapacitive coupling between a sensor electrode 220 and a sensor electrode 230 affected by input object(s). In another example, a capacitive pixel can correspond to an absolute capacitance of a sensor electrode 210. The determination module 260 can determine an array of capacitive coupling changes using the resulting signals obtained by the sensor circuitry 240 to produce an x-by-y array of capacitive pixels that form a capacitive image. The capacitive image can be obtained using transcapacitive sensing (e.g., transcapacitive image), or obtained using absolute capacitive sensing (e.g., absolute capacitive image). In this manner, the processing system 110 can capture a capacitive image that is a snapshot of the response measured in relation to input object(s) in the sensing region 120. A given capacitive image can include all of the capacitive pixels in the sensing region, or only a subset of the capacitive pixels.

In another example, the determination module 260 can perform a plurality of capacitance measurements associated with a particular axis of the sensing region 120 to create a “capacitive profile” along that axis. For example, the determination module 260 can determine an array of absolute capacitive coupling changes along an axis defined by the sensor electrodes 220 and/or the sensor electrodes 230 to produce capacitive profile(s). The array of capacitive coupling changes can include a number of points less than or equal to the number of sensor electrodes along the given axis.

Measurement(s) of capacitance by the processing system 110, such as capacitive image(s) or capacitive profile(s), enable the sensing of contact, hovering, or other user input with respect to the formed sensing regions by the sensor electrode collection 208. The determination module 260 can utilize the measurements of capacitance to determine positional information with respect to a user input relative to the sensing regions formed by the sensor electrode collection 208. The determination module 260 can additionally or alternatively use such measurement(s) to determine input object size and/or input object type.

Processing system 110A and processing system 110B also include a display driver 280 that drives display elements of input device 100 for display updates. In various embodiments, display driver 280 may drive gate lines and source lines, where gate lines select a row of display elements for display updating and source lines provide display update values to particular sub-pixel elements. In the description below, any portion (including all) of functionality related to display updating described as being performed by the processing system 110 may be considered to be performed by the display driver 280. Display driver 280 may be embodied as, or may include, a processing system configured to perform functionality described herein, by, for example, executing software or firmware instructions. Display driver 280 may alternatively or additionally include other non-processor hardware components configured to perform functionality described herein.

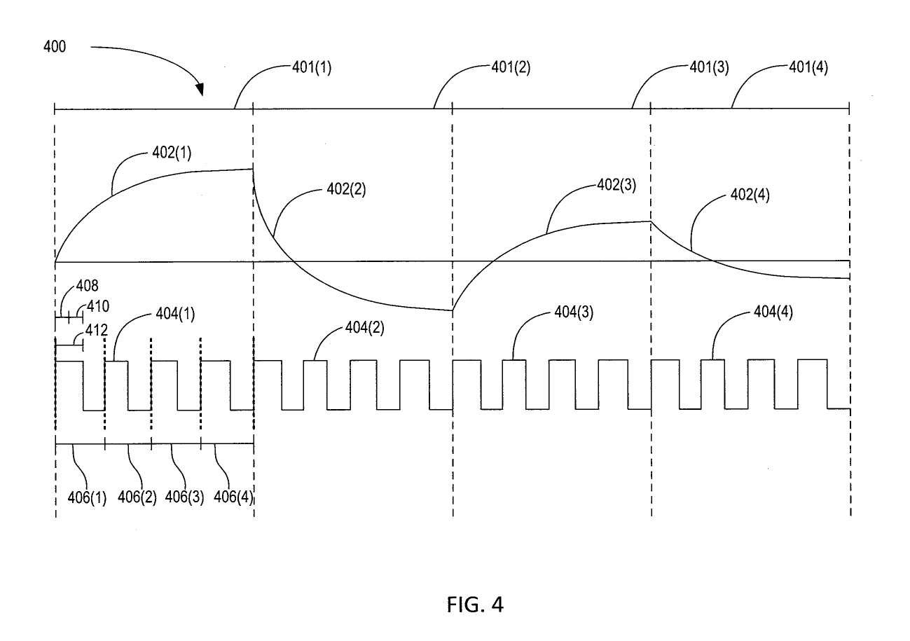

Processing system 110 may drive display elements and sensor electrodes (e.g., sensor electrodes 210, sensor electrodes 220, or sensor electrodes 230) of input device 100 in at least partially overlapping periods. For reasons discussed below with respect to FIG. 4, it is advantageous to drive sensor electrodes with signals that include an integer number of cycles in each display line update period, and with signals that have the same phase as display update signals (i.e., the relative phase between the sensing signals and the display line update signals is kept constant). However, driving sensor electrodes and display elements in such a manner has a constraining effect on the ability to perform “gear shifting” in order to avoid signal noise at certain frequencies. Additional details follow.

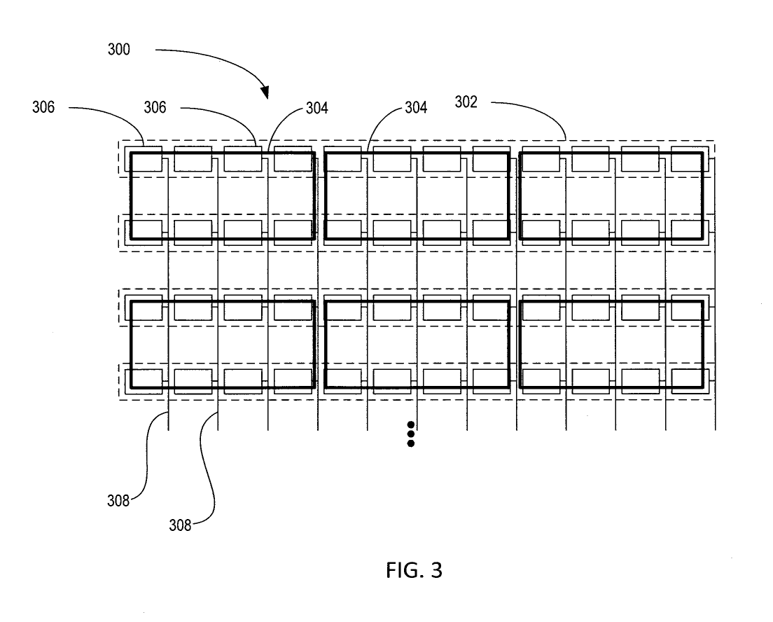

FIG. 3 is a block diagram of a portion 300 of input device 100 of FIG. 1, according to an example. Elements of the portion 300 of input device 100 are shown in a top-down view. Thus, sensor electrodes 304 are shown as being in a different layer than sub-pixel elements 306. As shown, the portion 300 of input device 100 includes display lines 302 as well as sensor electrodes 304. Display lines 302 each include sub-pixel elements 306 that are coupled to processing system 110 (not shown in FIG. 3) via source lines 308. Source lines 308 are selectively coupleable to different display lines 302 via switching mechanisms (not shown), which may comprise one or more transistors activated by gate select lines (also not shown) that act to select particular display lines 302 for display updates.

Note that the specific geometry of sensor electrodes 304 shown in FIG. 3 is just an example and that sensor electrodes 304 may be shaped and positioned in any technically feasible manner. Some other examples of the manner in which sensor electrodes 304 may be shaped and positioned are illustrated in FIGS. 2A and 2B. Note also that sensor electrodes 304 may be any of sensor electrodes 210 (FIG. 2B), sensor electrodes 220 (FIG. 2A), or sensor electrodes 230 (FIG. 2A).

To update a particular display line 302, processing system 110 directs a gate line (not shown in FIG. 3) corresponding to that display line 302 to be asserted and drives source lines 308 with source voltages that correspond to desired brightness for particular sub-pixel elements 306. Processing system 110 may implement a line-inversion scheme in which, within a single display frame, sub-pixel elements 306 in one particular display line 302 are driven with voltages that are of opposite polarity as compared with sub-pixel elements 306 in a neighboring display line 302. The term “polarity” indicates whether the voltage with which a particular sub-pixel element 306 is driven is above or below a reference voltage. Additionally, in the line inversion scheme, sub-pixel elements 306 are driven with opposite polarities in one frame as compared with in a next (or previous) consecutive frame. Processing system 110 may also implement a dot-inversion scheme, in which adjacent sub-pixel elements 306 of a particular display line 302 are driven with voltages of opposite polarities. Note that although specific inversion schemes are described herein, sub-pixel elements 306 may be driven in any technically feasible manner.

FIG. 4 is a timing diagram 400 that illustrates timing relationships between display driving and sensor electrode driving, according to an example. As shown, timing diagram 400 includes a series of display line periods 401 in which different display lines 302 are updated. During each display line period 401, a voltage update waveform 402 for application via a source line to a particular display sub-pixel element 306 is shown. Additionally, during each display line period 401, a sensing waveform 404 is shown. Voltage update waveforms 402 represents the voltage level at a particular sub-pixel element 306 as the voltage level changes over time due to an initial change in voltage driven via a source line and to a settling of the voltage over time due to the RC constant of the sub-pixel element 306. Sensing waveforms 404 represent sensor signals transmitted with a particular sensor electrode 304 during a particular display line period 401 for the purpose of performing sensing. Sensing waveforms 404 include an integer number of cycles 406, each of which represents a transition from low voltage to high voltage and back to low voltage. Thus, as shown, for capacitive sensing, processing system 110 drives sensor electrodes 304 with signals that include a plurality of cycles 406.

Note that although voltage update waveforms 402 are illustrated for a single display sub-pixel element 306, multiple sub-pixel elements 306 are updated during any particular display line period 401. The voltage update waveforms 402 for other sub-pixel elements 306 are not shown in FIG. 4, for clarity.

Note also that during each display line period 401, a sensing waveform 404 occurs. Note that two or more consecutively occurring sensing waveforms 404, that occur in two different display line periods 401 may represent sensor signals transmitted to the same sensor electrode 304 or to different sensor electrodes 304. Thus, sensing waveform 404(1) and sensing waveform 404(2) may represent sensing signals applied to the same sensor electrode 304 or to different sensor electrodes 304. In general, the act of sensing with any particular sensor electrode 304 may span multiple display line periods 401. Additionally, consecutive sensing waveforms 404 that occur in a single display line period 401 may represent sensor signals transmitted to the same sensor electrode 304.

Processing system 110 drives sensor electrodes 304 with sensing waveforms 404 that include a number of cycles 406 that is an integer multiple of the number of display line periods 401. However, the integer number of cycles 406 may vary for different display line periods. Additionally, processing system 110 drives sensor electrodes 304 with cycles 406 having the same phase relative to the phase of voltage update waveforms 402 for sub-pixel elements 306. Thus, voltage update waveforms 402 begin at approximately the same time as a first cycle 406 for a particular sensing waveform 404. In other words, the transition from high to low or low to high voltage associated with voltage update waveform 402 begins at approximately the same time as a voltage transition that begins the first cycle 406 of a sensing waveform 404.

The purpose of maintaining the integer ratio between sensing cycles 406 and display line periods 401 is to allow for management of noise injected into the touch signal by display updates. More specifically, due to physical proximity between display elements and sensor electrodes, changes in voltage on the source line and associated portions of the display elements induce a noise signal in the sensing signals received as a result of driving sensor electrodes with sensing waveform 404 (this received signal may be referred to herein as a “resulting signal”). To manage effects related to this noise signal, processing system 110 maintains a specific relationship between sensing voltage update waveforms 402 and the sensing waveforms 404. This relationship includes that the relative phase of the voltage update waveforms 402 and the sensing waveforms is the same, meaning that a transition to a different voltage starts at the same time in both the voltage update waveforms 402 and the sensing waveforms 404. The relationship maintained between the voltage update waveforms 402 and the sensing waveforms 404 also includes that within each display line period 401, an integer number of cycles 406 of the sensing waveform 404 occurs. Thus, the ratio between the number of display line periods 401 and the number of cycles 406 for sensing is an integer number.

Maintaining the above relationship causes the noise that is injected into the resulting signal to be predictable. For example, a large amount of noise is injected into a first cycle 406(1) of a display line period 401, caused by the large change in voltage associated with the beginning of a display line period 401. This predictability allows for easy management of the noise induced by the display signal. For example, the processing system 110 may attempt to avoid capturing capacitive signals during periods of high interference. A non-integer relationship would mean that, in each display line period 401, the noise injected into a resulting signal varies, which would result in more difficult noise management.

In some embodiments, processing system 110 removes some of the predictably generated noise from the resulting signal. In some embodiments, to generate a resulting signal, a charge integrator integrates charge received from a sensor electrode during a period termed the “integration period.” In some embodiments, to remove noise associated with the beginning of a display line period 401, the integration period may not begin until after a certain amount of time after the display line period 401 (and the first cycle 406(1)) begins. In some embodiments, the charge integrator includes an operational amplifier having capacitive feedback between the inverting input and an output. In such embodiments, delaying the integration period is accomplished by closing a reset switch connected in parallel with the capacitive feedback (i.e., to the inverting input of the op-amp and to the output) until the end of the delay of the integration period, and then opening that switch at the beginning of the integration period to allow for charge integration.

A sensing half-cycle 412 is shown, representing the period of the first cycle 406(1) in which the sensing signal voltage is high. During this sensing half-cycle 412, processing system 110 causes charge integration to not occur during a reset period 408 and then causes charge integration to occur during an integration period 410. Because the reset period 408 is associated with a greater change in display voltage than the integration period 410, avoiding charge integration during the reset period 408 removes a substantial amount of noise that would otherwise be captured by charge integration. Note that the length of the reset period 408 and integration period 410 may be varied. In some embodiments, the reset period 408 is at least approximately ten percent of the half-cycle 412 time. In some embodiments, the reset period 406 is at least approximately twenty percent of the half-cycle 412 time. Note also that although the reset functionality is only shown and described for a first half cycle 412 of a first sensing cycle 406(1) of a display line period 401, the reset functionality may be applied to any or all sensing half cycles within a display line period 401.

One issue with maintaining the ratio between sensing cycles 406 and display line periods 401 is that it is sometimes desirable to change the frequency of the sensing signal (i.e., the frequency associated with cycles 406) in response to issues such as noise. For example, if a prominent noise signal having a frequency close to the frequency of the sensing signal is present, then the ability of processing system 110 to derive meaningful information about the presence and/or position of an input object 140 may be hindered. In such situations, it is advantageous to change the frequency of the sensing signal to avoid the noise signal. However, the requirement for maintaining an integer ratio between sensing signal and display update signal presents a difficulty.

More specifically, while the length of the display line period 401 may be altered to some degree, a large change in this length is generally not possible. A large change is not possible because of timing constraints for to display update operations. More specifically, a change cannot increase the display line period 401 to too great a degree, because doing so could lengthen the time required for a full frame past a period associated with a specified frame rate (e.g., 60 Hz) for the display. Similarly, a change cannot decrease the display line period 401 to too great a degree, since with a short display line period 401, transistors may not be able to be turned on via gate signals in too short of a time period.

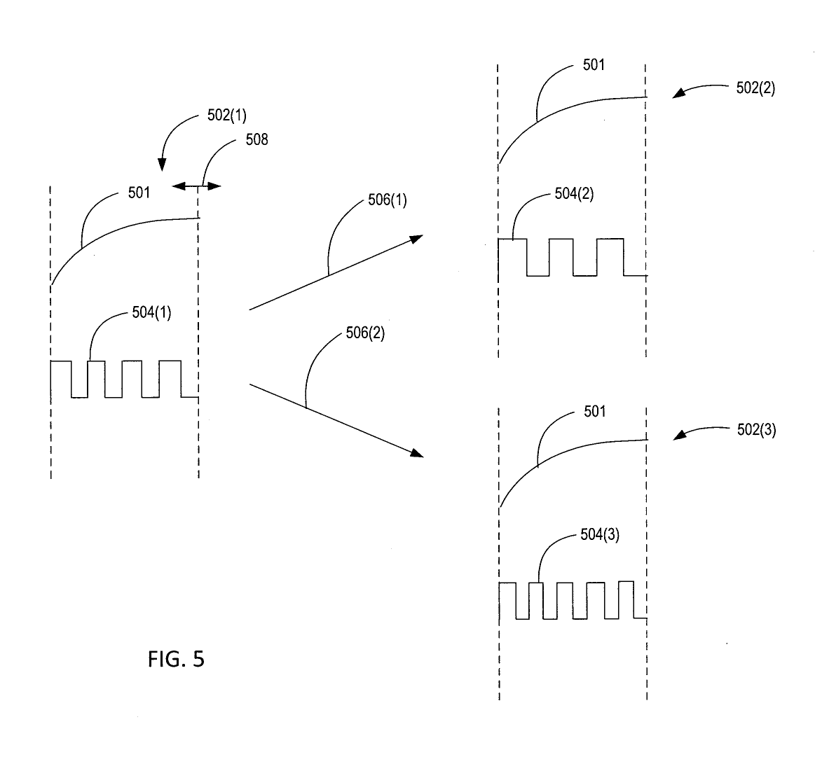

FIG. 5 illustrates a technique for changing frequency of a sensing signal, according to an example. In FIG. 5, a first state 502(1) is shown in which a sensing signal 504(1) is driven at a first integer ratio with respect to a display update signal 501. Note that display update signal 501 is analogous to voltage update waveform 402 of FIG. 4 and that sensing signals 504 are analogous to sensing waveforms 404 of FIG. 4. The particular integer ratio of first state 502(1) is 4:1, although other integer ratios are of course possible.

In response to detecting noise in a resulting signal, where the noise has a frequency that coincides with the frequency of the sensing signal 504, processing system 110 changes the frequency of the sensing signal 504. Processing system 110 may change the frequency of the sensing signal 504 by changing the length of the display line period 401 and holding the ratio between the number of sensing cycles 406 and display line periods 401 constant. Processing system may alternatively change the frequency of the sensing signal 504 by changing the ratio between the number of sensing cycles 406 and display line periods 401 while holding the display line period constant 401. Processing system may also change the frequency of the sensing signal 504 by both changing the ratio between the number of sensing cycles 406 and display line periods 401 and changing the length of the display line period 401.

In one example of changing the frequency of the sensing signal 504, processing system 110 causes a transition 506(1) to second state 502(2), in which the ratio is lower than in the first state (specifically, a 3:1 ratio). In another example, processing system 110 causes a transition 506(2) to third state 502(3), in which the ratio is higher than in the first state (specifically, a 5:1 ratio). By varying this ratio, the frequency of the sensing signal can be altered to avoid the detected noise signal.

Note that in addition to varying the integer ratio between sensing signal and display update signal, processing system 110 may also vary the duration of each display line period 401. The degree to which such duration may be altered is not very high as described above. However, by adjusting such duration, a greater range of sensing frequencies may be achieved by processing system 110. For example, changing the integer ratio without adjusting the display line period yields a, likely small, number of discrete sensing frequencies available to the processing system 110. However, changing the integer ratio along with the display line period allows further sensing frequencies surrounding those discrete sensing frequencies that arise due to the relationship between the ratio and the display line period. If the display line period can be adjusted sufficiently, it may be possible to have a continuous range of sensing frequencies according to some embodiments.

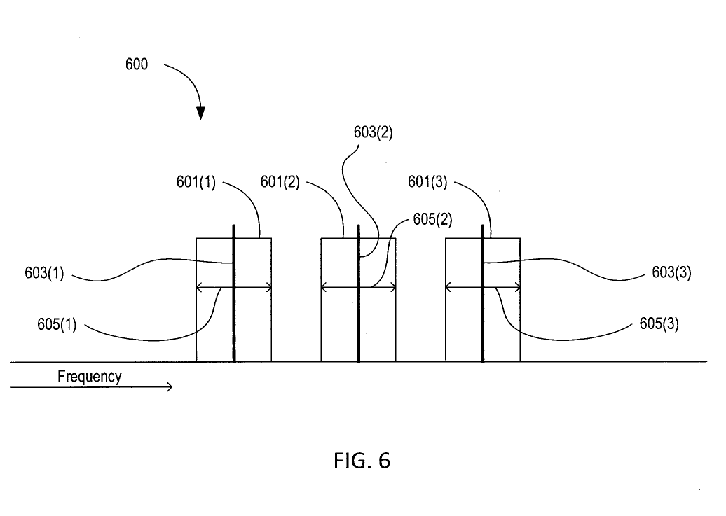

FIG. 6 is a spectrum chart 600 that illustrates sensing frequencies over which input device 100 may operate with techniques disclosed herein, according to an example. More specifically, spectrum chart 600 illustrates several frequency bands 601 that illustrate the frequencies of sensing signals the processing system 110 may drive onto sensor electrodes for capacitive sensing.

Each band 601 is defined by a central frequency 603 and a frequency range 605. The central frequency 603 is achieved by varying the ratio of the number of cycles in the sensing signal to the number of display line periods and the frequency range 605 represents the degree to which the sensing signal frequency can be varied by varying the duration of the display line periods. Mathematically, the frequencies that are possible for the sensing signal can be expressed as follows:

f_{T}=m(f₀+x)

where f_{T} is the sensing signal frequency, m is the integer ratio between sensing signal and display line, f₀ is the line update period, and x is an adjustment to the line update period.

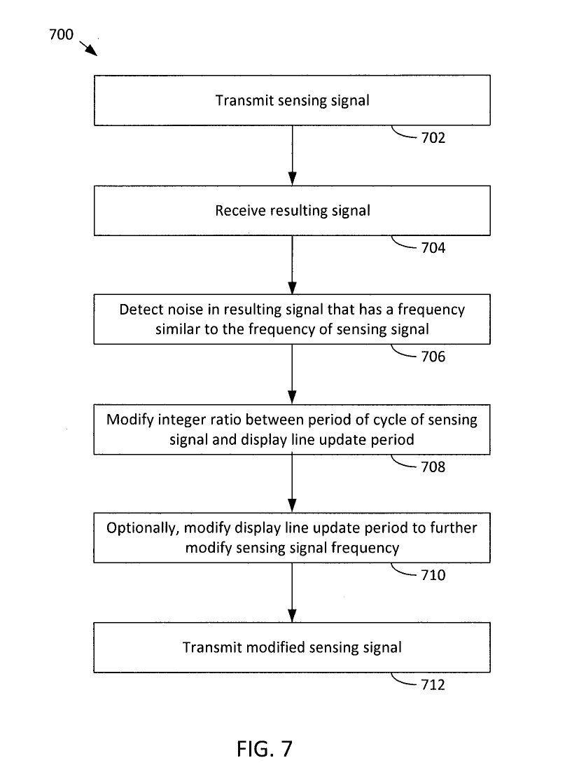

FIG. 7 is a flow diagram of a method 700 for adjusting sensing signal frequency, according to an example. Although described with respect to the system of FIGS. 1-3, those of skill in the art will understand that any system configured to perform the steps in various alternative orders is within the scope of the present disclosure.

As shown, the method 700 begins at step 702, where processing system 110 transmits a sensing signal on a sensor electrode (such as sensor electrode 304). At step 704, processing system 110 receives a resulting signal that includes effects corresponding to presence of an input object 140 in a sensing region 120. At step 706, processing system 110 detects noise in the resulting signal that has a frequency that is similar to the frequency of the sensing signal. In some embodiments, “similar” in this context means substantially equal to or within a few percent (e.g., up to 10%) of.

At step 708, processing system 110 modifies the integer ratio that defines the number of cycles of the sensing signal in each display line update period. The ratio can be reduced or increased. At step 710, processing system 110 optionally changes the length of the display line update period, which also changes the frequency of the sensing signal. At step 712, processing system 110 transmits a sensing signal with a frequency that is altered as compared with the sensing signal of step 702, onto a sensor electrode.

Thus, the embodiments and examples set forth herein were presented in order to best explain the present invention and its particular application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed.

It should be understood that while many embodiments of the invention are described in the context of a fully functioning apparatus, the mechanisms of the present invention are capable of being distributed as a program product (e.g., software) in a variety of forms. For example, the mechanisms of the present invention may be implemented and distributed as a software program on information bearing media that are readable by electronic processors (e.g., non-transitory computer-readable and/or recordable/writable information bearing media readable by the processing system 110). Additionally, the embodiments of the present invention apply equally regardless of the particular type of medium used to carry out the distribution. Examples of non-transitory, electronically readable media include various discs, memory sticks, memory cards, memory modules, and the like. Electronically readable media may be based on flash, optical, magnetic, holographic, or any other storage technology.

What is claimed is:

1. A method for driving display updates and performing sensing, the method comprising:
driving a first plurality of display source lines for a first plurality of display line updates, wherein a first amount of time between a beginning of two consecutive display line updates of the first plurality of display line updates comprises a first display line time;
driving a plurality of capacitive sensor electrodes to perform a first number of sensing cycles during each of the first plurality of display line updates;
driving a second plurality of display source lines for a second plurality of display line updates, wherein a second amount of time between a beginning of two consecutive display line updates of the second plurality of display line updates comprises a second display line time; and
driving the plurality of capacitive sensor electrodes to perform a second number of sensing cycles during each of the second plurality of display line updates, wherein the second number of sensing cycles is different from the first number of sensing cycles.

2. The method of claim 1, wherein the first display line time is the same as the second display line time.

3. The method of claim 1, wherein the first display line time is different from the second display line time.

4. The method of claim 3, wherein a first ratio of the first display line time to the second display line time is different than a second ratio of the first number of sensing cycles to the second number of sensing cycles.

5. The method of claim 1, wherein driving the plurality of capacitive sensor electrodes with the second number of sensing cycles is performed responsive to detecting interference at a sensing frequency corresponding to the first number of sensing cycles.

6. The method of claim 1, wherein a beginning of a first sensing cycle of the first number of sensing cycles coincides with a beginning of the first display line time.

7. The method of claim 1, wherein an integration period of a first sensing cycle of the first number of sensing cycles is delayed from a beginning of the first sensing cycle.

8. The method of claim 1, wherein a number of sensing cycles that occurs in a display frame is an integer multiple of a number of display line times that occurs in the display frame.

9. The method of claim 8, wherein, during the display frame, each display line is updated.

10. A processing system for driving display updates and performing sensing, the processing system comprising:
a display driver configured to:
drive a first plurality of display source lines for a first plurality of display line updates, wherein a first amount of time between a beginning of two consecutive display line updates of the first plurality of display line updates comprises a first display line time, and
drive a second plurality of display source lines for a second plurality of display line updates, wherein a second amount of time between a beginning of two consecutive display line updates of the second plurality of display line updates comprises a second display line time; and
sensor circuitry configured to:
drive a plurality of capacitive sensor electrodes to perform a first number of sensing cycles during each of the first plurality of display line updates, and
drive the plurality of capacitive sensor electrodes to perform a second number of sensing cycles during each of the second plurality of display line updates, wherein the second number of sensing cycles is different from the first number of sensing cycles.

11. The processing system of claim 10, wherein the first display line time is the same as the second display line time.

12. The processing system of claim 10, wherein the first display line time is different from the second display line time.

13. The processing system of claim 12, wherein a first ratio of the first display line time to the second display line time is different than a second ratio of the first number of sensing cycles to the second number of sensing cycles.

14. The processing system of claim 10, wherein driving the plurality of capacitive sensor electrodes with the second number of sensing cycles is performed responsive to detecting interference at a sensing frequency corresponding to the first number of sensing cycles.

15. The processing system of claim 10, wherein a beginning of a first sensing cycle of the first number of sensing cycles coincides with a beginning of the first display line time.

16. The processing system of claim 10, wherein an integration period of a first sensing cycle of the first number of sensing cycles is delayed from a beginning of the first sensing cycle.

17. The processing system of claim 10, wherein a number of sensing cycles that occurs in a display frame is an integer multiple of a number of display line times that occurs in the display frame.

18. The method of claim 17, wherein, during the display frame, each display line is updated.

19. An input device for performing display updates and performing sensing, the input device comprising:
display source lines coupled to display elements, the display source lines including a first plurality of display source lines and a second plurality of display source lines;
a plurality of capacitive sensor electrodes; and
a processing system, comprising:
a display driver configured to:
drive the first plurality of display source lines for a first plurality of display line updates, wherein a first amount of time between a beginning of two consecutive display line updates of the first plurality of display line updates comprises a first display line time, and
drive the second plurality of display source lines for a second plurality of display line updates, wherein a second amount of time between a beginning of two consecutive display line updates of the second plurality of display line updates comprises a second display line time; and
sensor circuitry configured to:
drive the plurality of capacitive sensor electrodes to perform a first number of sensing cycles during each of the first plurality of display line updates, and
drive the plurality of capacitive sensor electrodes to perform a second number of sensing cycles during each of the second plurality of display line updates, wherein the second number of sensing cycles is different from the first number of sensing cycles.

20. The input device of claim 19, wherein a first ratio of the first display line time to the second display line time is different than a second ratio of the first number of sensing cycles to the second number of sensing cycles.
